(19) United States
(12) Patent Application Publication
(10) Pub. No.: US 2012/0167014 A1
(43) Pub. Date: Jun. 28, 2012

(54) VISUAL SURROGATE FOR INDIRECT EXPERIENCE AND APPARATUS AND METHOD FOR PROVIDING THE SAME

(75) Inventors: Sang-Hyun Joo, Daejeon (KR); Sang-Won Ghyme, Daejeon (KR); Jae-Hwan Kim, Daejeon (KR); Hyo-Taeg Jung, Daejeon (KR)

(73) Assignee: Electronics and Telecommunications Research Institute, Daejeon (KR)

(21) Appl. No.: 13/331,670

(22) Filed: Dec. 20, 2011

(30) Foreign Application Priority Data
Dec. 23, 2010 (KR) 10-2010-0133935

(51) Int. Cl. G06F 3/048; G09G 5/00

(52) U.S. Cl. 715/849; 345/633

(57) ABSTRACT

Disclosed herein is a technology for utilizing an indirect experience without copying a real world to a virtual world. An apparatus for providing a visual surrogate for indirect experience according to an embodiment of the present invention includes a synchronization setup unit for setting up synchronization models between a surrogate, a real object and virtual objects corresponding to the surrogate and the real object, wherein the surrogate is a substitute for a remote user and the virtual objects are displayed in a control space. A control space generation unit generates the control space required to input commands for the surrogate and the real object and to output surrounding information sensed by the surrogate. A service provision unit generates an application in which the synchronization models and the control space are packaged.

### CROSS REFERENCE TO RELATED APPLICATION

This application claims the benefit of Korean Patent Application No. 10-2010-0133935, filed on Dec. 23, 2010, which is hereby incorporated by reference in its entirety into this application.

### BACKGROUND OF THE INVENTION

1. Technical Field

The present invention relates generally to indirect experience technology represented by virtual reality and augmented reality and, more particularly, to technology for overcoming technical restrictions that occur during a procedure of combining a virtual world with a real world.

2. Description of the Related Art

In the prior art, virtual experience was possible only in an environment in which a user had an inexact indirect experience using a kind of device as in games, or simulations conducted for a short period of time. However, with recent technological trends such as the generalization of media, the digitalization of various types of multimedia content, and the development of communication networks, technology related to virtual experience has also developed at a rapid pace.

In particular, the growth and development of the virtual world have been emphasized as being a method for a user to experience a temporally and spatially restricted environment which the user otherwise could not experience. There are technologies such as Virtual Reality (VR) technology for configuring a virtual environment and providing a user with indirect experience, and Augmented Reality (AR) technology for adding virtual information to a real environment.

There has been gradual progress in virtual reality and augmented reality technologies. However, these technologies are implemented such that a user has a virtual experience from a first-person point of view. A virtual world service, such as a second life, has been produced so as to overcome the user's spatial restrictions. In this service, it is possible to move in space to the place a user desires to move to, and the user can experience in the third-person point of view using an avatar in such an environment. Further, this service also enables spatial movement that was impossible in the real world by copying the real world to the virtual world without change, and then a user can gain various experiences in that space.

However, even in this case, a lot of time, labor and equipment are required to construct a virtual world that is a copy of reality, and a large amount of resources are also required to apply variations in the real world to the virtual world.

Therefore, the necessity for technology for improving reliability when a user has an indirect experience by reducing the consumption of resources attributable to the construction of a virtual world and by more exactly applying the real world to the virtual world has increased.

### SUMMARY OF THE INVENTION

Accordingly, the present invention has been made keeping in mind the above problems occurring in the prior art, and an object of the present invention is to provide a technology for indirect experience that allows objects or the like in a real world to be used without change in a virtual world, without needing to copy the real world to the virtual world in such a way that all elements of the real world are individually applied to the virtual world.

Another object of the present invention is to provide a technology for indirect experience that consumes an extremely small amount of resources when constructing a virtual world, and eliminates a distinction between the virtual world and the real world, thus further improving reliability.

In accordance with an aspect of the present invention to accomplish the above objects, there is provided an apparatus for providing a visual surrogate for indirect experience, including a synchronization setup unit for setting up synchronization models between a surrogate, a real object and virtual objects corresponding to the surrogate and the real object, wherein the surrogate is a substitute for a remote user and the virtual objects are displayed in a control space; a control space generation unit for generating the control space required to input commands for the surrogate and the real object and to output surrounding information sensed by the surrogate; and a service provision unit for generating an application in which the synchronization models and the control space are packaged.

Preferably, the synchronization setup unit may match and map the virtual objects with and to the surrogate and the real object using a preset template, and thus sets up the synchronization models.

Preferably, the control space generation unit may generate the control space required to input the commands for the surrogate and the real object by manipulating the virtual objects based on a multimodal interface.

Preferably, the surrogate may be a movable instrument including a device for sensing the surrounding information including images, voices, temperature and humidity of surroundings, and short-range and long-range communication means. Alternatively, the surrogate may be an instrument including a device for sensing the surrounding information, short-range and long-range communication means, moving means, and three-dimensional (3D) image output means, the surrogate being configured to output a human-shaped 3D image to outside of the instrument.

Preferably, the service provision unit may individually transmit the application both to the user and to the surrogate.

In accordance with another aspect of the present invention to accomplish the above objects, there is provided a visual surrogate for indirect experience, including a command analysis unit for analyzing a command received from a remote user to manipulate a virtual object present in a control space; a surrogate control unit for matching and mapping the virtual object with and to a real object corresponding to the virtual object by using an externally received synchronization model, and generating a control command required to manipulate the real object in compliance with the analyzed command; an object control unit for manipulating the real object in compliance with the control command; and an operation control unit for controlling a physical operation required to manipulate the real object in compliance with the control command.

Preferably, the control space may be a space generated in an input device of the remote user, and configured to input the surrogate control command based on a multimodal interface.

Preferably, the command analysis unit may further include a function of analyzing a command received from the user to manipulate a virtual object corresponding to the visual surrogate.

Preferably, the surrogate control unit may generate an operation control command for the visual surrogate when the virtual object is the visual surrogate.

Preferably, the object control unit may include a function of remotely manipulating the real object using wired or wireless communication. The operation control unit may directly manipulate the real object using a physical operation.

Preferably, the visual surrogate may further include a sensor unit for sensing surrounding information including images, voices, temperature and humidity of surroundings. In this case, the surrogate control unit may further include a function of outputting the sensed surrounding information so as to display the surrounding information in the control space.

Preferably, the surrogate control unit may include three-dimensional (3D) image output means for outputting a human-shaped 3D image to outside of the visual surrogate.

Preferably, the operation control unit may function to control operations of moving means of the visual surrogate, of an articulated arm of the visual surrogate, and of a robotic hand connected to the arm and configured to be capable of physically manipulating the real object.

In accordance with a further aspect of the present invention to accomplish the above objects, there is provided method of providing a visual surrogate for indirect experience, including a control space generation unit generating a virtual object corresponding to a surrogate, which is a substitute for a remote user, in a control space; a synchronization setup unit setting up synchronization models between the surrogate, a real object and virtual objects corresponding to the surrogate and the real object, wherein the virtual objects are displayed in the control space; the control space generation unit generating the control space required to input commands for the surrogate and the real object and to output surrounding information sensed by the surrogate; and a service provision unit generating an application in which the synchronization models and the control space are packaged.

Preferably, the setting up the synchronization models may be configured to match and map the virtual objects with and to the surrogate and the real object using a preset template, and thus to set up the synchronization models.

Preferably, the generating the control space may be configured to generate the control space required to input the commands for the surrogate and the real object by manipulating the virtual objects based on a multimodal interface.

Preferably, the surrogate may be a movable instrument including a device for sensing the surrounding information including images, voices, temperature and humidity of surroundings, and short-range and long-range communication means or, alternatively, an instrument including a device for sensing the surrounding information, short-range and long-range communication means, moving means, and three-dimensional (3D) image output means, the surrogate being configured to output a human-shaped 3D image to outside of the instrument.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an apparatus for providing a visual surrogate for indirect experience according to an embodiment of the present invention;

FIG. 2 is a block diagram showing a visual surrogate for indirect experience according to an embodiment of the present invention;

FIG. 3 is a diagram showing an example of the manipulation of a surrogate using a multimodal interface;

FIG. 4 is a diagram showing an example in which a control space is displayed on a user input screen;

FIG. 5 is a diagram schematically showing a mutual relation between a control space, a virtual object, a surrogate, and a real object; and

FIG. 6 is a flowchart showing a method of providing a visual surrogate for indirect experience according to an embodiment of the present invention; and

FIG. 7 is a flowchart showing the flow of control over the surrogate in a control space.

### DESCRIPTION OF THE PREFERRED EMBODIMENTS

Hereinafter, a visual surrogate for indirect experience and an apparatus and method for providing the visual surrogate according to embodiments of the present invention will be described with reference to the attached drawings. In the following description, the same reference numerals are used to designate the same or similar components.

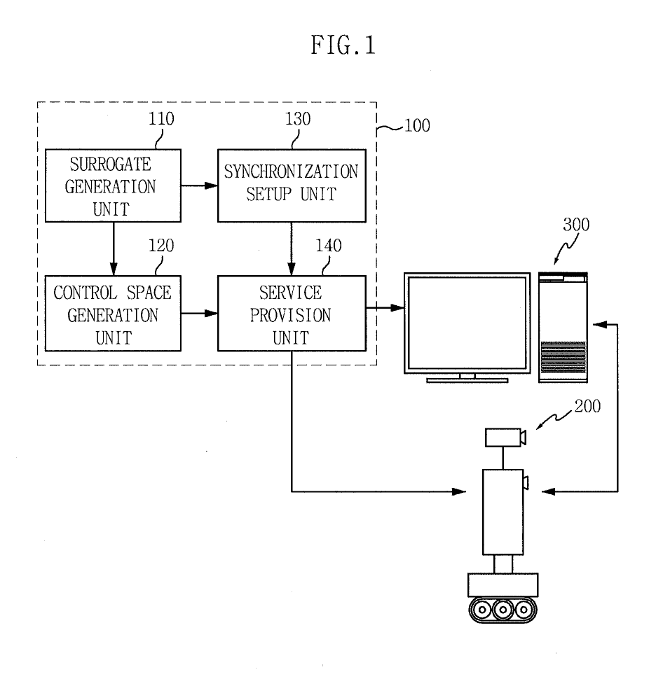

FIG. 1 is a block diagram showing an apparatus for providing a visual surrogate for indirect experience according to an embodiment of the present invention.

Referring to FIG. 1, an apparatus 100 for providing visual surrogate for indirect experience according to an embodiment of the present invention is characterized in that it includes a synchronization setup unit 130, a control space generation unit 120, and a service provision unit 140. The apparatus 100 may further include a surrogate generation unit 110.

First, in order to display a virtual object for a surrogate 200, which is a tangible/intangible substitute that replaces a remote user, in a control space, the surrogate generation unit 110 receives information about the surrogate 200 and generates data corresponding to the virtual object. Further, the surrogate generation unit 110 performs basic settings to control the surrogate 200.

For example, the surrogate 200 is assumed to be a viewing robot located at a remote famous aquarium. In this case, in order for a user to have an indirect experience as if he or she were viewing the famous aquarium, the surrogate generation unit 110 conducts basic settings so that the user can access the surrogate 200, which is a movable robot that is provided in the aquarium and that is capable of capturing images and voices, to control the surrogate 200.

For example, the surrogate generation unit 110 may analyze the input of a user input device, and then initially determine whether the surrogate 200 is present in a space the user desires to experience. Further, the surrogate generation unit 110 may generate information about a virtual object of a human shape or a specific shape, which allows the user to control the surrogate 200 in the control space.

In an embodiment of the present invention, the surrogate 200 denotes a tangible or intangible substitute for the user. For the indirect experience of the user, the surrogate 200 must be movable and must include the function of acquiring surrounding information and manipulating real objects. Further, the surrogate 200 must include a communication device for performing the function of transmitting the acquired surrounding information to a user input device 300 and receiving commands from the user input device 300, or the function of remotely manipulating the real objects.

Therefore, the surrogate 200 may be, for example, an instrument that includes a movable robot or the like including devices such as a plurality of sensors capable of sensing surrounding information that includes images, voices, temperature and humidity of surroundings, and short-distance and long-distance communication means.

Further, the surrogate 200 may include a three-dimensional (3D) image output means, together with the above devices and means, so that it can be seen like the shape of a human being to other persons in the real world in which the surrogate is present. Here, the 3D image output means may output a 3D image having a human shape to the outside of the surrogate 200, thus allowing the surrogate to be seen like a human being. In this case, the 3D image may have the same shape as a human shape displayed by the surrogate generation unit 110 and the control space generation unit 120.

The synchronization setup unit 130 functions to set up synchronization models between the surrogate 200, a real object and virtual objects. The surrogate 200 is a substitute for a remote user. The virtual objects correspond to the surrogate 200 and the real object, and are displayed in a control space. The synchronization setup unit 130 sets up synchronization so as to be able to actually control the surrogate 200 and the real object at the same time that the user manipulates the virtual objects in the control space.

For example, the synchronization setup unit 130 receives information about the virtual object generated by the surrogate generation unit 110. The information about the virtual object received by the synchronization setup unit 130 may include the shape of each virtual object, a model enabling the virtual object to be recognized in the control space, and information about the surrogate 200 corresponding to the virtual object, that is, information about the location, shape, function, etc. of the surrogate 200.

Further, the synchronization setup unit 130 may implement a real object, captured or recognized by the surrogate 200, as a virtual object so as to represent the real object in the control space in a manner that depends on the type of surrogate 200. That is, only an object in the real world, which is determined to be operable by the surrogate 200, is represented as a virtual object. This representation as a virtual object means that an instrument or an article that is operable in the surrounding environment captured by the surrogate 200 is objectified to be selectable in the control space in the embodiment of the present invention. However, a method of implementing an operable instrument or article as a new object and displaying the new object in the control space may also be used.

The synchronization setup unit 130 performs matching and mapping between the virtual object generated to correspond to the surrogate 200 or the real object and the actual surrogate 200 or real object by using a preset template. As described above, the surrogate 200 and the real object are articles located far away from the user. Therefore, in order to manipulate and control both the surrogate 200 and the real object by manipulating the virtual objects present in the control space, the synchronization setup unit 130 generates synchronization models.

That is, such a synchronization model refers to a model generated to perform mapping between a virtual object and a real object, mapping between the manipulation of the virtual object and the actual manipulation of the real object, and space-time matching between the virtual object and the real object.

The synchronization model converts a command corresponding to the manipulation of the virtual object into a command for the surrogate 200 using a predetermined template, and synchronizes the command with the manipulation of the virtual object. Therefore, the user manipulates only the virtual object in the control space, so that the surrogate 200 is manipulated, and thus the real object can also be manipulated.

The control space generation unit 120 functions to generate the control space required to input commands for the surrogate 200 and the real object and required to output surrounding information sensed by the surrogate 200. That is, the control space generation unit 120 generates an environment in which an actual user input screen is provided.

The control space generation unit 120 receives information about previously generated virtual objects and generates image or text information to represent the above-described virtual objects on the user input screen so that the user can manipulate the virtual objects.

The control space is implemented using the models which are synchronized between the surrogate 200, the real world and the virtual object and which are set up by the synchronization setup unit 130. The control space may be reconfigured by the control space generation unit 120, and a tool for editing the control space may be provided to the user.

The control space is a space that functions to provide an interface between the user and the surrogate 200. The control space may be basically represented on the display unit of the user input device 300 such as a computer. The user may manipulate the surrogate 200 using the control space 200, or manipulate the remote real object using the surrogate 200.

In an embodiment of the present invention, the control space generation unit 120 manipulates virtual objects using a multimodal interface, thus generating the control space to which commands for the surrogate 200 and for the real object are input.

The multimodal interface refers to an interface between a human being and a computer or a terminal device, and allows information to be input using various types of media such as a keyboard, a pen, a mouse, graphics, and voices, and information to be output using various types of media such as voices, graphics, and 3D images. For such a multimodal interface, a multimodal interaction working group of World Wide Web Consortium (W3C) has established standards such as multimodal interaction framework, Extensible Multimodal Annotation (EMMA) and ink markup language standards.

Further, the control space supports the outputting of images and voices captured by the surrogate 200 so that the user has an indirect experience. When a control space provision program generated by the control space generation unit 120 is executed on the user input device 300, the user may check surrounding information sensed by the surrogate 200, and manipulate the surrogate 200, which replaces the user, from a third-person point of view, thus gaining an indirect experience for the remote real world.

For example, the user may view an aquarium via the surrogate 200, which is present in a remote aquarium, in the control space. Further, a computer screen or a service provision apparatus present in the aquarium may be manipulated via the surrogate 200, thus enabling functions that can be utilized in the aquarium to be used in the control space represented by the user input device 300.

The control space generation unit 120 analyzes the intention of the user using synchronization models so as to describe interactions between the virtual objects, the surrogate 200, and the real object, and generates the control space to synchronize the space-time of the real object with the space-time of the control space.

The service provision unit 140 functions to generate an application in which the synchronization models and the control space are packaged. That is, the service provision unit 140 generates the application to provide a program, enabling the generated synchronization models and the generated control space to be used, to the user input device 300 so that the user can substantially manipulate the surrogate 200 using the user input device 300. Simultaneously, the service provision unit 140 may also transmit the application to the surrogate 200. The surrogate 200 may receive the application and output a 3D image desired to be displayed by the user, thus enabling a human-shaped 3D image corresponding to the user to be output to the outside of the surrogate 200. Further, the surrogate 200 may receive the application so as to be able to perform various functions depending on the control space and the synchronization models that have been customized to each user, and may manipulate the application in compliance with the user's command.

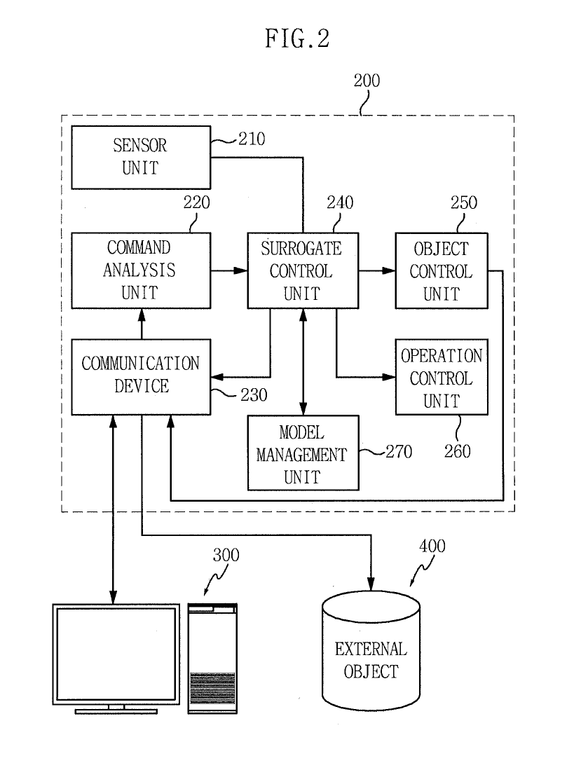

FIG. 2 is a block diagram showing the visual surrogate for indirect experience according to an embodiment of the present invention. In the following description, a description of repeated parts that are similar to those of FIG. 1 will be omitted.

Referring to FIG. 2, a visual surrogate 200 for indirect experience according to an embodiment of the present invention includes a command analysis unit 220, a surrogate control unit 240, an object control unit 250, and an operation control unit 260. For the additional operation of the surrogate 200, the visual surrogate 200 may further include a sensor unit 210, a communication device 230, and a model management unit 270.

The command analysis unit 220 analyzes a command received from a remote user to manipulate a virtual object present in the control space. The control space may be displayed on the display unit of the user input device 300, and the user may manipulate the virtual object present in the control space.

The results of the manipulation of the virtual object are transferred to the command analysis unit 220 in real time via the communication device 230. The command analysis unit 220 analyzes the manipulation of the user on the virtual object, and then determines which type of command has been given to the virtual object.

For example, it is assumed that the user, performs an operation of commanding an air conditioner to be turned off by manipulating virtual objects via the control space in such a way as to manipulate a virtual object corresponding to the surrogate 200 and a virtual object corresponding to an air conditioner spaced apart from the surrogate. In this case, the command analysis unit 220 receives information about a procedure in which the virtual object of the surrogate 200 approaches the virtual object of the air conditioner and a procedure in which the virtual object of the surrogate 200 turns off the air conditioner by manipulating the virtual object of the air conditioner.

In this case, the command analysis unit 220 transfers to the surrogate control unit 240 the results of the analysis related to the manipulation performed by the user on the virtual object. In the above example, the analysis results are transferred to indicate that a command for moving the virtual object corresponding to the surrogate 200 to the virtual object corresponding to the air conditioner, a command for turning off the virtual object corresponding to the air conditioner, etc. have been input to the control space by the user input device 300.

Similarly to the description of FIG. 1, the input of a control command for a virtual object to the control space may be performed by the user input device 300 on the basis of the multimodal interface.

In the embodiment of the present invention, the command analysis unit 220 may transfer the user's input command for the virtual object in real time to the surrogate control unit 240, thus enabling the user's input to the control space to be applied in real time to the actual surrogate 200 and the real object which is the external object 400.

The surrogate control unit 240 matches and maps the virtual object with and to a real object corresponding to the virtual object using synchronization models, and then generates a control command required to manipulate the real objects in compliance with the analyzed command.

The command analysis unit 220 analyzes in real time which type of command has been input in relation to the virtual object, and transfers the results of the analysis to the surrogate control unit 240. The surrogate control unit 240 recognizes a real object corresponding to a virtual object for which the command has been input by using a pre-stored synchronization model, and then performs matching and mapping between the real object and the virtual object. Further, when the virtual object performs a series of operations in compliance with the command input by the user input device 300, the surrogate control unit 240 detects which operations of the surrogate and the real object, which correspond to virtual objects, are coincident with the operations of the virtual object, and then performs mapping.

For example, when a virtual object manipulated by the user is the surrogate 200, the surrogate control unit 240 may prepare for the generation of an operation control command for the surrogate 200 itself. Further, when the virtual object takes the action of turning off the air conditioner, an operation in which the surrogate 200 stretches out an articulated robotic arm and clicks the power button of the air conditioner to turn off the power thereof, or control which is required to stop the operation of the air conditioner by the remote manipulation on the air conditioner via short-range communication of the surrogate 200 may be mapped to the commands corresponding to the action.

When the command for the virtual object analyzed by the analysis unit 220 is received, the surrogate control unit 240 generates a control command required to manipulate the actual surrogate 200 and the real object using the above procedure.

The surrogate control unit 240 may further include the function of outputting sensed surrounding information to display the surrounding information of the surrogate 200 sensed by the sensor unit 210 in the control space. Since the shape of the real world must be captured and displayed in the control space unchanged because of the characteristics of the present invention, the surrogate control unit 240 transfers the surrounding information acquired by the sensor unit 210 to the user input device 300 via the communication device 230, thus allowing the surrounding information to be displayed in the control space currently being represented on the user input device 300.

Therefore, in an embodiment of the present invention, the visual surrogate 200 may include the sensor unit 210 for sensing surrounding information, including the images, voices, temperature and humidity of the surroundings of the surrogate 200. In particular, a device for capturing images of the surroundings may be implemented as either a single camera or a plurality of cameras used to realize 3D stereoscopic images. Preferably, a plurality of cameras must be installed so that the user can view and manipulate the surrogate 200 from a third-person point of view.

Further, the surrogate 200 may include the model management unit 270. The model management unit 270 may function to store a plurality of control models for the surrogate 200 and synchronization models corresponding to the control models, and to provide the surrogate control unit 240 with a control model and a synchronization model that are suitable to the control space or the user. The control models denote a list of control functions that may be performed by the surrogate 200 using the synchronization models. By way of these control models, control customized to each user may be performed. As a result, in the indirect experience using the surrogate 200, various advantages of allowing the user to feel better as if he or she were experiencing the corresponding environment and of improving the user's convenience can be obtained.

The object control unit 250 manipulates the external object 400 using the surrogate 200. In an embodiment of the present invention, the object control unit 250 may be connected to the communication device 230. That is, the object control unit 250 functions to remotely manipulate the external object 400 by transferring a predetermined control command to the external object 400 to be manipulated using the surrogate 200, that is, the real object, via a communication function.

For example, when the user performs control to turn off an air conditioner by manipulating a virtual object corresponding to the surrogate 200 in the control space and then manipulating a virtual object corresponding to the air conditioner, the surrogate control unit 240 generates an actual control command mapped to such control, as described above.

That is, the surrogate control unit 240 may generate a control command required to generate a signal that remotely turns off the air conditioner and may provide this signal to the object control unit 250 of the surrogate 200. The object control unit 250 may perform control to turn off the air conditioner in the same manner that a remote control is remotely manipulated by activating an air conditioner manipulation function while receiving the control command.

According to an embodiment of the present invention, in order to distinguish the operations of the surrogate 200, the function of the object control unit 250 is limited to the function of remotely manipulating a real object via the communication device 230, but the object control unit 250 may have the same meaning as the operation control unit 260. That is, in the case where an object cannot be controlled by the communication device 230 of the surrogate 200, the physical operation of the surrogate 200 is controlled by the operation control unit 260, thus enabling the object to be manipulated.

The operation control unit 260 functions to control the operations of the physical components of the surrogate 200 in compliance with commands generated by the surrogate control unit 240. That is, the surrogate control unit 240 may control and manipulate a real object by controlling the surrogate 200 when a virtual object is a real object to be controlled, and may generate operating control commands for the surrogate 200 when the virtual object is just the surrogate 200. Control performed to merely move the surrogate 200 without manipulating any real object may be taken as an example of such control.

Further, the operation control unit 260 may function to control the surrogate 200 in conjunction with the object control unit 250 so that the surrogate 200 takes predetermined actions to control a real object. For example, when a house is intended to be cleaned using a cleaner, a normal cleaner cannot be operated using only a communication function.

Therefore, the surrogate 200 can be controlled so that the operation control unit 260 can freely move to a predetermined area with the cleaner by utilizing an articulated robotic arm and a moving means while the object control unit 250 controls the power and operating state of the cleaner.

By the above procedure, the user may efficiently have an indirect experience, such as remotely carrying out household chores or viewing an aquarium, using the surrogate 200 which replaces the user from a third-person point of view.

The surrogate 200 may be personally purchased by the user or, alternatively, a plurality of surrogates 200 may be disposed in areas in which indirect experience services are provided, so that when users access the indirect experience service, each user can be connected to the surrogate 200 for a designated time. Accordingly, the user can indirectly experience the real world in the same situation without personally visiting a relevant space and without individually copying all elements of the real world to create the virtual experience.

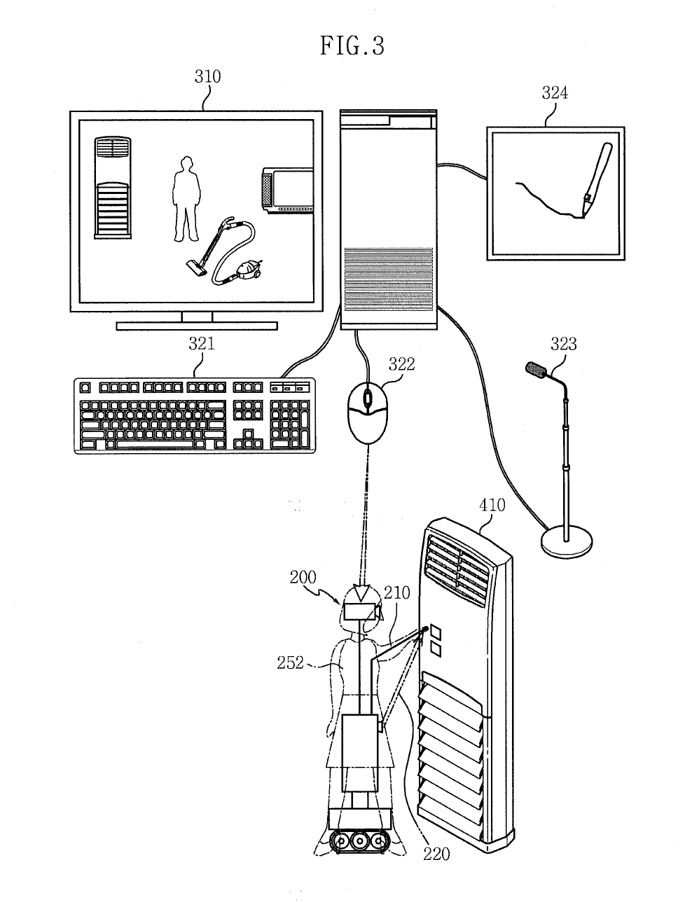

FIG. 3 is a diagram showing an example of the manipulation of the surrogate using a multimodal interface. In the following description, a description of repeated parts that are similar to those of FIGS. 1 and 2 will be omitted.

Referring to FIG. 3, a control space is displayed on the display unit 310 of the user input device 300. Such a control space is a kind of programmed space, and may be suitably modified and displayed depending on the display unit 310 of each user input device 300. The control space denotes an environment in which the user can manipulate virtual objects.

The user may perform an input operation of manipulating virtual objects using a touch input scheme or using a keyboard 321, a mouse 322, a pen mouse 324 or a microphone 323, according to the type of display unit 310. In addition to the input means shown in FIG. 3, any type of input means may be used as long as it is available on the multimodal interface.

At the same time that virtual objects displayed on the display unit 310 are manipulated, the control of the surrogate 200 may be initiated. Since a 3D image 252 including a hologram is output from the surrogate 200 through a 3D image output device (not shown), other persons may recognize that the surrogate 200 is being controlled by another person and has the shape of a human being while simultaneously viewing both the surrogate 200 and the 3D image 252 or viewing only the 3D image 252.

On the surrogate 200, a physical operating means 260 and a communication device 230 may be provided. The communication device 230 may be connected to an object control unit 250 and transmit a control command signal to a real object 410 so that the real object 410 can be controlled. However, as described above with reference to FIGS. 1 and 2, the communication device 230 may also communicate with the surrogate provision apparatus 100 and the user input device 300.

The surrogate 200 may manipulate the real object 410 via the physical operating means 260 or the communication device 230. By means of this manipulation, the user may have an indirect experience as if he or she were personally manipulating the real object by manipulating the virtual object displayed on the display unit 310.

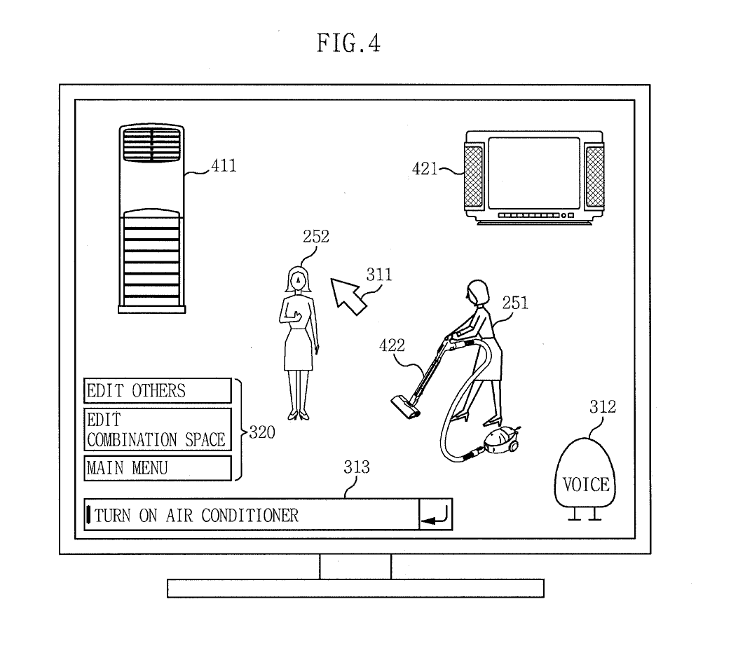

FIG. 4 is a diagram showing an example in which the control space is displayed on a user input screen. In the following description, a description of repeated parts that are similar to those of FIGS. 1 to 3 will be omitted.

Referring to FIG. 4, on the user input screen, that is, the display unit 310 of the user input device 300, various menus and images may be displayed. On the display unit 310, a menu 320 for editing and utilizing the control space may be present. As stated in the description of FIG. 1, since an editing tool for the control space may be provided to the user input device 300, the user may edit the control space to suit his or her preferences using the editing menu.

Further, on the display unit 310, input means display menus 311, 312, and 313 for displaying various types of input means may be displayed. That is, the cursor 311 of a mouse, the text input box 313 using a keyboard, the voice input box 312, etc. may be present. When the display unit 310 is a touch screen, the user may perform input by personally making a touch on the display unit 310.

On the display unit 310, various virtual objects 251, 252, 411, 421, and 422 that may be present in the control space may be displayed. First, 3D images 251 and 252 for the surrogate 200 may be displayed. The user may have a sensation similar to that of personally operating a human being on the screen from a third-person point of view by manipulating only the 3D images 251 and 252 without needing to personally recognize the surrogate 200. However, according to the user's selection, the shape of the surrogate 200 instead of the 3D images 251 and 252 may be used without change.

Further, on the display unit 310, various real objects 411, 421 and 422 that may be manipulated by the surrogate 200 may be displayed. Of course, although not shown in FIG. 4, images in the real world, including the surface of a wall or a bottom that cannot be manipulated by the surrogate 200, may also be displayed.

The real objects 411, 421 and 422 able to be manipulated may be displayed using a predetermined display means (for example, bold solid lines or blinking solid lines). Whether real objects are able to be manipulated may be determined by the control space generation unit 120 and the synchronization setup unit 130 of the surrogate provision apparatus 100.

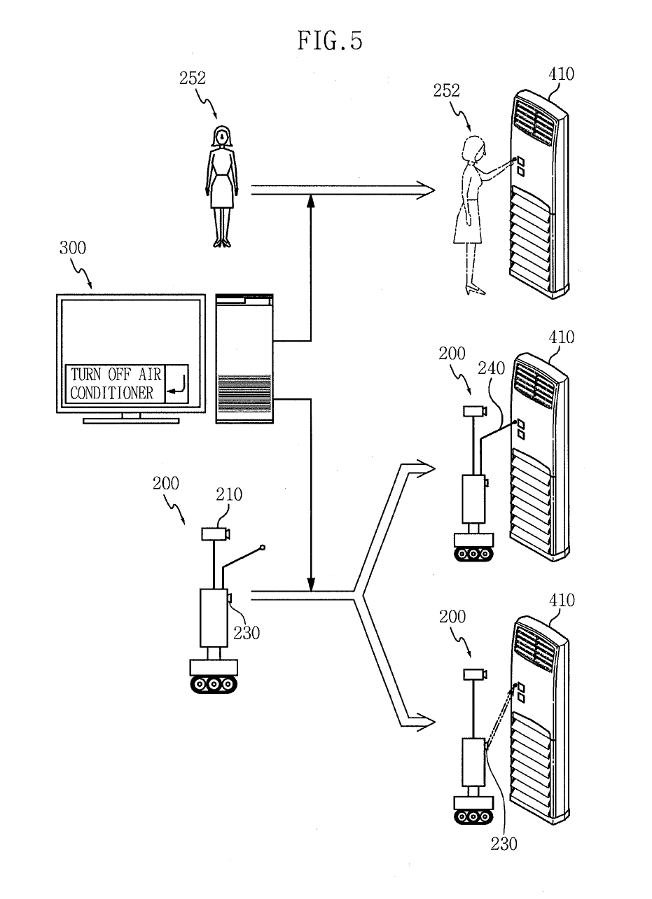

FIG. 5 is a diagram schematically showing a mutual relationship between a control space, a virtual object, a surrogate, and a real object.

Referring to FIG. 5, a 3D image 252, which is the virtual object of the surrogate 200 displayed on the display unit that is the control space, may be synchronized with the surrogate 200. Similarly, a real object 410 to be manipulated may be synchronized with a virtual object (not shown) displayed on the display unit of the user input device 300.

When a command for directing the operation of the real object 410 indicating an air conditioner to be turned off is input to the control space displayed on the display unit of the user input device 300, an image indicting that the virtual object 252 of the surrogate 200 moves and presses the power button of the air conditioner to turn off the air conditioner may be displayed on the display unit, as in the case of the uppermost image on the right side of FIG. 5.

At the same time, in the real world, the operation may be performed in which the surrogate 200 moves and approaches the real object 410, and then turns off the power of the air conditioner, which is the real object 410 corresponding to the virtual object, by using the short-range communication function and the remote manipulation function of the robotic arm 260 or the communication device 230 and the object control unit 250. The user may monitor such an operation in real time in the form of an image or the like, and may also determine whether the operation has been normally performed via the display unit.

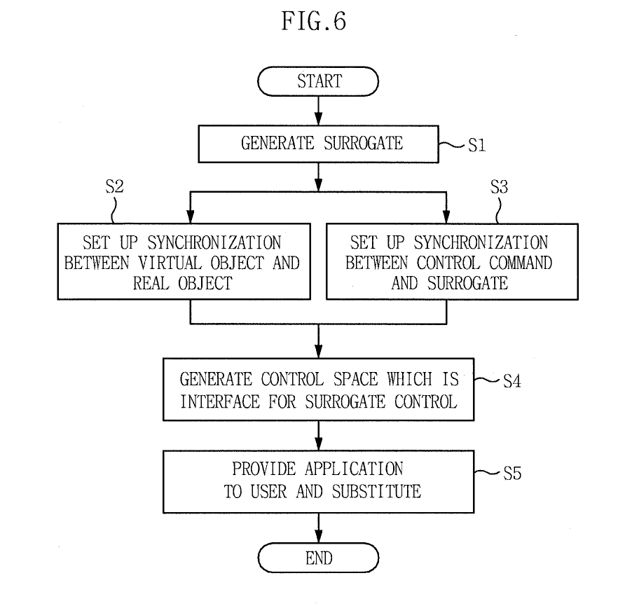

FIG. 6 is a flowchart showing a method of providing a visual surrogate for indirect experience according to an embodiment of the present invention. In the following description, a description of repeated parts that are similar to those of FIGS. 1 to 5 will be omitted.

Referring to FIG. 6, in the method of providing a visual surrogate for indirect experience according to an embodiment of the present invention, step S1 is performed such that in order to display the virtual object of the surrogate 200, which is a tangible or intangible substitute for a remote user, in the control space, the surrogate generation unit 110 receives information about the surrogate 200 and generates data corresponding to the virtual object, and such that the control space generation unit 120 generates the virtual object corresponding to the surrogate which replaces the remote user in the control space.

Thereafter, the synchronization setup unit 130 sets up synchronization models between the surrogate and the real object to be manipulated and virtual objects corresponding to the surrogate and the real object to be manipulated in the control space at step S2. Further, synchronization models between control commands and the control type of the surrogate are set up at step S3. The description of the synchronization models is similar to that of FIGS. 1 to 5.

Thereafter, the control space generation unit 120 generates a multimodal interface-based control space required to control both the surrogate 200 and the real object based on the surrogate 200 at step S4. The control space may be realized, together with the synchronization models, on the user input device 300 and may be displayed on the display unit 310, as described above.

Thereafter, the service provision unit 140 may generate an application in which the synchronization models and the control space are packaged, and may provide the application to the user input device 300 or to the surrogate 200 at step S5.

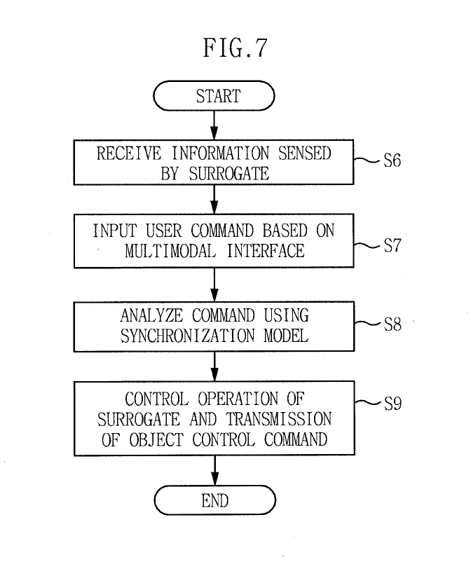

FIG. 7 is a flowchart showing the flow of control over the surrogate in the control space. That is, FIG. 7 illustrates the flow of a series of indirect experiences executed by the display unit 310 of the user input device 300 and the surrogate 200.

Referring to FIG. 7, surrounding information sensed by the sensor unit 210 is transferred to the user input device 300 via the surrogate control unit 240 and the communication device 230 at step S6. The user input device 300 displays the surrounding information in the control space.

Thereafter, a user's command is input by a multimodal interface-based input system at step S7. For example, the user manipulates virtual objects in the control space using all input schemes using, for example, images, text, voices, etc.

The command analysis unit 220 transmits a series of manipulation procedures, generated by analyzing the manipulation of the user on the virtual objects, to the surrogate control unit 240. The surrogate control unit 240 generates control commands for the actual surrogate 200 and the real object using synchronization models that have been received or have been selected by the model management unit 270, together with the manipulation procedures, at step S8.

Thereafter, the object control unit 250 and the operation control unit 260 included in the surrogate 200 control the operation of the surrogate 200 or the real object in compliance with the control commands received from the surrogate control unit 240 at step S9.

The above-described present invention is not intended to limit the scope of the claims of the present invention. Further, it is apparent that in addition to the embodiments of the present invention, equivalent inventions for performing the same function as the present invention also belong to the spirit and scope of the present invention.

According to the present invention, there is an advantage in that in an indirect experience environment or a ubiquitous environment, an indirect experience can be had without having to individually copy elements of a real space. The reason for this is that in a control space in which images captured by a surrogate are displayed, a virtual object which is the result of capturing a real object is manipulated, and thus an indirect experience is obtained. Therefore, resources consumed by an indirect experience can be minimized, and the effect of inducing the user to more realistically have an indirect experience can be anticipated.

What is claimed is:

1. An apparatus for providing a visual surrogate for indirect experience, comprising:
a synchronization setup unit for setting up synchronization models between a surrogate, a real object and virtual objects corresponding to the surrogate and the real object, wherein the surrogate is a substitute for a remote user and the virtual objects are displayed in a control space;
a control space generation unit for generating the control space required to input commands for the surrogate and the real object and to output surrounding information sensed by the surrogate; and
a service provision unit for generating an application in which the synchronization models and the control space are packaged.

2. The apparatus of claim 1, wherein the synchronization setup unit matches and maps the virtual objects with and to the surrogate and the real object using a preset template, and thus sets up the synchronization models.

3. The apparatus of claim 1, wherein the control space generation unit generates the control space required to input the commands for the surrogate and the real object by manipulating the virtual objects based on a multimodal interface.

4. The apparatus of claim 1, wherein the surrogate is a movable instrument comprising a device for sensing the surrounding information including images, voices, temperature and humidity of surroundings, and short-range and long-range communication means.

5. The apparatus of claim 1, wherein the surrogate is an instrument comprising a device for sensing the surrounding information including images, voices, temperature and humidity of surroundings, short-range and long-range communication means, moving means, and three-dimensional (3D) image output means, the surrogate being configured to output a human-shaped 3D image to outside of the instrument.

6. The apparatus of claim 1, wherein the service provision unit comprises a function of individually transmitting the application both to the user and to the surrogate.

7. A visual surrogate for indirect experience, comprising:
a command analysis unit for analyzing a command received from a remote user to manipulate a virtual object present in a control space;
a surrogate control unit for matching and mapping the virtual object with and to a real object corresponding to the virtual object by using an externally received synchronization model, and generating a control command required to manipulate the real object in compliance with the analyzed command;
an object control unit for manipulating the real object in compliance with the control command; and
an operation control unit for controlling a physical operation required to manipulate the real object in compliance with the control command.

8. The visual surrogate of claim 7, wherein the control space is a space generated in an input device of the remote user, and configured to input the surrogate control command based on a multimodal interface.

9. The visual surrogate of claim 7, wherein the command analysis unit further comprises a function of analyzing a command received from the user to manipulate a virtual object corresponding to the visual surrogate.

10. The visual surrogate of claim 7, wherein the surrogate control unit comprises a function of generating an operation control command for the visual surrogate when the virtual object is the visual surrogate.

11. The visual surrogate of claim 7, wherein the object control unit comprises a function of remotely manipulating the real object using wired or wireless communication.

12. The visual surrogate of claim 7, further comprising a sensor unit for sensing surrounding information including images, voices, temperature and humidity of surroundings.

13. The visual surrogate of claim 12, wherein the surrogate control unit further comprises a function of outputting the sensed surrounding information so as to display the surrounding information in the control space.

14. The visual surrogate of claim 7, wherein the surrogate control unit comprises three-dimensional (3D) image output means for outputting a human-shaped 3D image to outside of the visual surrogate.

15. The visual surrogate of claim 7, wherein the operation control unit controls operations of moving means of the visual surrogate, of an articulated arm of the visual surrogate, and of a robotic hand connected to the arm and configured to be capable of physically manipulating the real object.

16. A method of providing a visual surrogate for indirect experience, comprising:
a control space generation unit generating a virtual object corresponding to a surrogate, which is a substitute for a remote user, in a control space;
a synchronization setup unit setting up synchronization models between the surrogate, a real object and virtual objects corresponding to the surrogate and the real object, wherein the virtual objects are displayed in the control space;
the control space generation unit generating the control space required to input commands for the surrogate and the real object and to output surrounding information sensed by the surrogate; and
a service provision unit generating an application in which the synchronization models and the control space are packaged.

17. The method of claim 16, wherein the setting up the synchronization models is configured to match and map the virtual objects with and to the surrogate and the real object using a preset template, and thus to set up the synchronization models.

18. The method of claim 16, wherein the generating the control space is configured to generate the control space required to input the commands for the surrogate and the real object by manipulating the virtual objects based on a multimodal interface.

19. The method of claim 16, wherein the surrogate is a movable instrument comprising a device for sensing the surrounding information including images, voices, temperature and humidity of surroundings, and short-range and long-range communication means.

20. The method of claim 16, wherein the surrogate is an instrument comprising a device for sensing the surrounding information including images, voices, temperature and humidity of surroundings, short-range and long-range communication means, moving means, and three-dimensional (3D) image output means, the surrogate being configured to output a human-shaped 3D image to outside of the instrument.
